(19) United States
(12) Patent Application Publication
(10) Pub. No.: US 2005/0089204 A1
(43) Pub. Date: Apr. 28, 2005

(54) Rolled print prism and system

(75) Inventors: John F. Carver, Palm City, FL (US); George W. McClurg, Jensen Beach, FL (US)

Correspondence Address: STERNE, KESSLER, GOLDSTEIN & FOX PLLC, 1100 NEW YORK AVENUE, N.W., WASHINGTON, DC, 20005, US

(73) Assignee: Cross Match Technologies, Inc.

(21) Appl. No.: 10/969,016

(22) Filed: Oct. 21, 2004

Related U.S. Application Data
(60) Provisional application No. 60/513,033, filed on Oct. 22, 2003.

(51) Int. Cl. G06K 9/00

(52) U.S. Cl. 382/127

(57) ABSTRACT

A live print scanner includes a prism having a concave platen surface to receive a digit (e.g., a finger). The prism has light input and output faces. An illumination system is configured to illuminate the concave platen surface. A camera system includes a camera that detects image data representative of a rolled print in a scan, while the digit, platen surface, illumination system, and camera system are stationary during the scan. Alternatively, the illumination system and/or the camera system can move during the scan.

### CROSS-REFERENCE TO RELATED APPLICATIONS

The present application claims the benefit of U.S. Provisional Patent Application No. 60/513,033, filed on Oct. 22, 2003, which is incorporated by reference herein in its entirety.

### BACKGROUND OF THE INVENTION

1. Field of the Invention

The present invention relates to the field of biometrics. More specifically, the present invention relates to live scanning of prints.

2. Background Art

Print imaging systems can capture images of prints on thumbs, fingers, palms, toes, feet, and/or hands. Such print imaging systems are also referred to as live scanners, live print scanners, or simply scanners. Live scanners often include a light source, platen and camera. An object having a print pattern is placed on the platen. A platen is often one planar surface of a prism. The light source illuminates the platen. The camera (also called a detector) captures an image of a print placed on the platen.

Live print scanners utilize the optical principle of frustrated total internal reflection (TIR) to capture a high-quality image of a print pattern. Such a print pattern includes ridges and valleys that make up all or part of a print. For example, ridges on a finger can operate to alter the refraction index at a platen surface compared to valleys, thereby interrupting the TIR of light at the platen surface. This interruption in the TIR causes a high quality optical image representative of the ridges and valleys of a print pattern to be captured by a camera.

Different types of prints can be captured. One type of print, called a rolled print, involves rolling a digit along a platen. A digit includes, but is not limited to, a finger, thumb, or toe. For example, a finger is placed on its side on a platen and then rolled about a longitudinal axis of the finger until its opposite side is on the platen. During the roll, the print pattern on the platen is scanned. Image data representing a rolled print is then detected by a camera. The image data for the rolled print covers the print pattern that extends from side to side around the entire digit. Biometric data (such as, fingerprint minutia data) can later be extracted from the rolled print image data. The various minutiae included in fingerprint minutia data include unique and measurable physical characteristics of a print (e.g., the starting and ending point of ridges and ridge junctions among features). Rolled print data is required in many applications such as law enforcement and civil Automated Fingerprint Identification System (AFIS) applications that require a ten-print format. A ten-print format usually requires, among other things, capturing roll prints of ten digits of a person (four fingers and a thumb on both right and left hands).

Typical applications for capturing rolled prints include the use of optical, capacitive, or ultrasonic technology implemented using a flat platen surface. In order to obtain rolled prints using a flat platen surface, a subject's fingers, for example, must each be individually manipulated by a trained operator. In addition, capturing rolled prints in this manner can be difficult. Rolling a digit across a platen is a complicated movement. During a roll, a digit may lift off the platen resulting in a poor quality image and loss of data. Sometimes a digit roll may have to be repeated to capture a roll print successfully. Some people, due to inexperience, arthritis or other conditions may have a difficult time pressing a print pattern evenly on a platen while rolling a digit or keeping the digit properly positioned on the platen. Indeed, in many applications such as a police booking station, a trained person must be present to assist in the rolling of a person's finger or thumb. Mechanical rolling of a digit to capture a roll print is also slow.

Alternatively, a concave platen has been used so a digit can rest on the platen while a scanning system moves along an arcuate path about the digit. This scan captures an image of the print pattern extending around the digit like a rolled print but with the advantage that a digit need not be rolled. This technique also has drawbacks. Movement of the scanning system about a finger is mechanically complicated, slow, expensive, and tends to increase the size of a scanning system. See, U.S. Pat. No. 4,537,484 issued to Fowler et al. and U.S. Pat. No. 4,783,167 issued to Schiller et al.

Further, the United States Department of Justice (DOJ) has recently established a set of goals for obtaining ten-print data. One of these goals is to capture ten-print data including ten rolled prints in less than one minute. See “Fingerprints for Border Security,” Aware, Inc., white paper, page 8 of 14 pages (2003). A major portion of the time currently spent obtaining the data required for a ten-print format involves the capture of ten rolled fingerprints.

What is needed is an improved rolled print system and method. A fast and effective live scanner is needed for capturing roll print data.

### BRIEF SUMMARY OF THE INVENTION

The present invention provides systems and methods for rolled print scanning. In an embodiment, a live print scanner includes a prism having a concave platen surface to receive a digit (e.g., a finger). The prism has light input and output faces. An illumination system is configured to illuminate the concave platen surface. A camera system includes a camera that detects image data representative of a rolled print in a scan, while the digit, platen surface, illumination system, and camera system are stationary during the scan. Alternatively, the illumination system and/or the camera system can move during the scan.

Further embodiments, features, and advantages of the present invention, as well as the structure and operation of the various embodiments of the present invention are described in detail below with reference to the accompanying drawings.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the pertinent art to make and use the invention.

FIG. 1 is a perspective view of a rolled print scanner and prism according to an embodiment of the present invention.

FIG. 2 shows example platen coatings.

FIG. 3A is a diagram illustrating a prism according to an embodiment of the present invention.

FIG. 3B is a diagram illustrating a prism according to an embodiment of the present invention.

FIG. 4 is a diagram illustrating different views of the prism of FIG. 3B.

FIG. 5 is a diagram illustrating an exemplary flow of light through the prism of FIG. 3B.

FIG. 6 illustrates an exemplary view of bright field illumination.

FIGS. 7A and 7B illustrate bright field illumination using a prism according to an embodiment of the present invention.

FIGS. 8A and 8B illustrate dark field illumination using a prism according to an embodiment of the present invention.

FIGS. 9A-9C are diagrams illustrating the shape of a prism according to an embodiment of the present invention.

FIGS. 9D-9E are diagrams illustrating different views of the prism exemplified in FIGS. 9A-9C.

FIGS. 10A and 10B illustrate an example of a rolled print image obtained using the prism shown in FIGS. 9D-9E.

FIG. 11 is a diagram illustrating a prism having a tapered slot according to an embodiment of the present invention.

FIG. 12 is a diagram illustrating a prism having a non-cylindrical (flared) slot according to an embodiment of the present invention.

FIG. 13 illustrates example shapes of the concave platens according to embodiments of the present invention.

FIGS. 14A and 14B illustrate multiple digit image capture according to embodiments of the present invention.

FIG. 15 is a flowchart illustrating a method for scanning a digit having a print pattern according to an embodiment of the present invention.

FIG. 16 is a flowchart illustrating a method for capturing a print image of a digit having a print pattern according to an embodiment of the present invention.

FIG. 17 is a flowchart illustrating a method for capturing print images of fingers and thumbs of both hands of a person according to an embodiment of the present invention.

FIGS. 18A and 1 8B illustrate an alternative shape for a prism, according to an embodiment of the present invention.

FIGS. 19A and 19B illustrate another alternative shape for a prism, according to an embodiment of the present invention.

FIG. 20 is a photograph of a prism of FIG. 3B.

FIG. 21 is a photograph of the prism of FIGS. 9D-9E.

The features, objects, and advantages of the present invention will become more apparent from the detailed description set forth below when taken in conjunction with the drawings in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

The present invention provides a uniquely shaped platen and print scanner which can capture rolled print image data quickly without requiring movement of a digit or scanner system element during scanning. While the present invention is described herein with reference to illustrative embodiments for particular applications of live print scanning and biometrics, it should be understood that the invention is not limited thereto. Those skilled in the art with access to the teachings provided herein will recognize additional modifications, applications, and embodiments with the scope thereof and additional fields in which the present invention would be of significant utility.

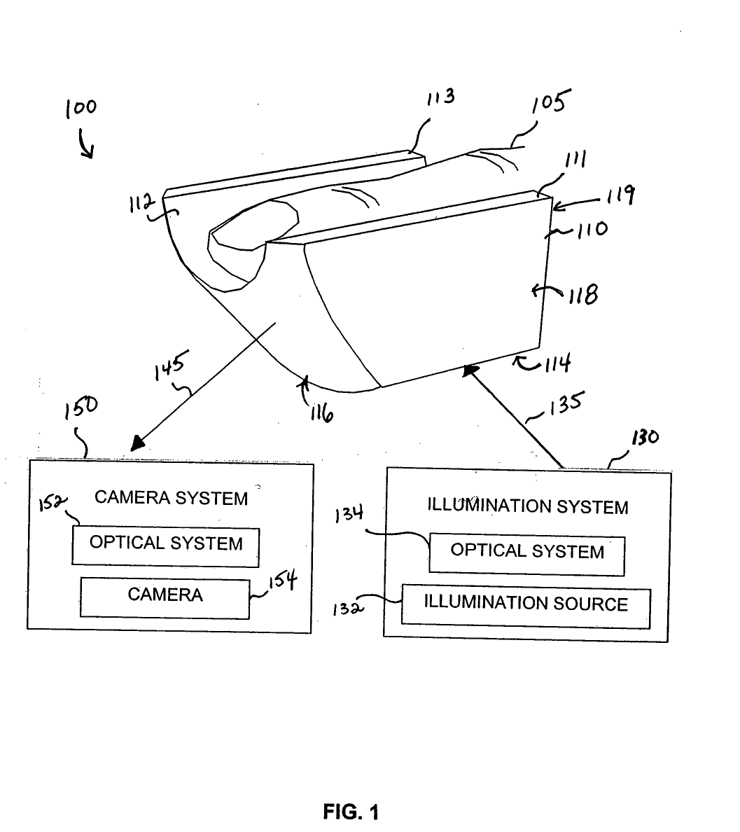

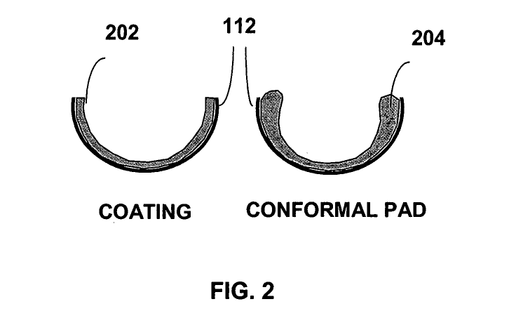

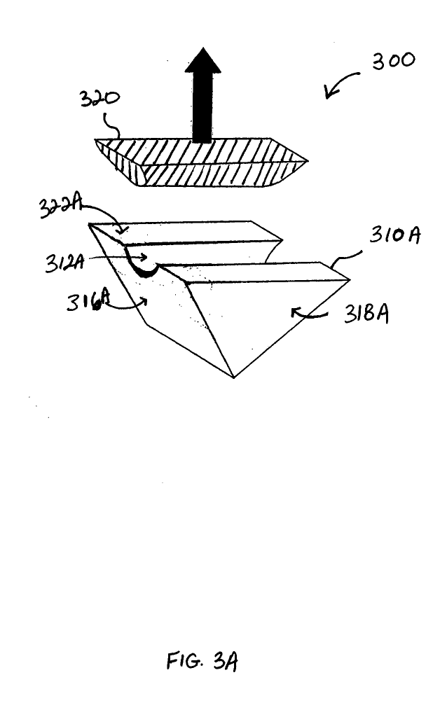

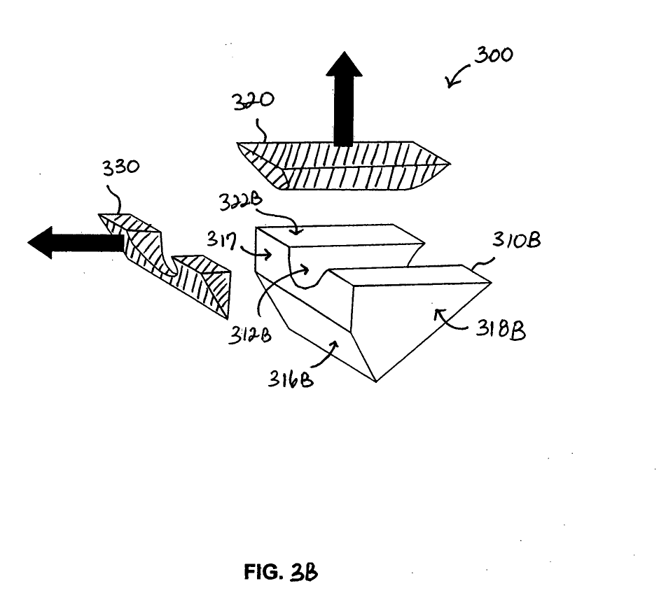

FIG. 1 is a perspective view of rolled print scanner 100 according to an embodiment of the present invention. Rolled print scanner 100 includes a prism 110 having a concave platen 112 upon which a digit 105 (e.g., a finger or thumb of either hand) is placed. A prism, platen, and all related components can be manufactured from a transparent material capable of passing a beam of light to enable detection of a print image. Examples of transparent materials are plastic, glass, silicone, or other suitable optical materials. Platen 112 can be a surface of prism 110 as shown in the top surface of prism 110 of FIG. 1. In the alternative, platen 112 can be a surface of other transparent material, such as a protective silicone layer, placed in optical contact with a concave surface of prism 110. See, for example, platen surface coating 202 in FIG. 2. Platen surface coatings are useful in enhancing dry fingerprint ridges. Platen surface coatings other than silicone can also be used. For example, in one embodiment, platen 112 can be an ultra-violet (UV) cured, cross-linked polyacrylate coating with controlled compliance. As an alternative to a platen coating, softer, more conformal pads can be used to compensate for slight physical variations from digit to digit in order to provide the best fit for a particular digit. See, for example, conformal pad 204 in FIG. 2.

In one preferred example, platen 112 is a slot having an elongate, concave shape between side edges 111, 113 that can receive a digit 105 and make contact with the print pattern thereon. In particular, the print pattern extending from side to side around a digit 105 can make contact with platen 112 while the digit is stationary as shown in FIG. 1.

Prism 110 includes light input face 114 and output face 116. In FIG. 1, light input face 114 is a bottom face of prism 110, and light output face 116 is a front face of prism 110. (In alternative embodiments and as described below, the light input and output faces can be swapped.) Prism 110 also has a rear face 119 and side faces (though only side face 118 is shown in the view of FIG. 1). Light from an illumination system 130 travels along an optical path 135, enters light input face 114 and is incident upon platen 112. Light reflected out of prism 110 through output face 116 passes along optical path 145 to a camera system 150.

Illumination system 130 includes an illumination source 132 and an optical system 134 that generates an appropriate illumination beam. Camera system 150 includes an optical system 152 that focuses an image of the print pattern onto a camera 154. Camera 154 detects an image of the print pattern extending from one side of digit 105 across to the other side. In this way, image data corresponding to a rolled print can be captured quickly without rotation of digit 105. Camera system 150 can be stationary during a scan with a cross-sectional scan area that covers an entire print pattern for the rolled print. For instance, in this case, camera 154 may be an area image detector, such as a charge-coupled device (CCD) array or CMOS detector that can capture an image of an imaging area covering the entire rolled print. Alternatively, camera system 150 and/or illumination system 130 can move during a scan to capture scan images with a smaller cross-sectional scan area but still cover an entire print pattern for the rolled print. The scan motion can be a relatively simple motion (such as straight path along the length of a finger or perpendicular to a finger capturing line scan images) compared to a complex arcuate path sweeping around and perpendicular to a finger. For instance, in this case, camera 154 may be a linear image detector such as a linear CCD or CMOS detector that captures a series of line scan images across an imaging area. The series of line scan images can be combined to make up an image of the entire rolled print.

FIG. 3A is a diagram illustrating a prism 310A according to an embodiment of the present invention. Prism 310A is a prism that could be used in the rolled print scanner 100 of FIG. 1 in place of prism 110. Prism 31 OA can be thought of as a section of a polyhedron, in this case a five-sided prism 300, remaining after a radial section 320 is removed from a platen side as shown in FIG. 3A. Such a radial section 320 can be removed during manufacture by any variety of techniques including, but not limited to, cutting, sanding, polishing, or casting in a shaped mold. The slot remaining after the removal of radial section 320 is used for platen 312A.

Prism 310A includes a top face 322A, which is the platen side, a front face 316A, two approximately parallel side faces (only side face 318A is shown), and a rear face (not shown). Top face 322A includes a concave area in between two side edge areas which forms a slot. The side faces of prism 310A are depicted in FIG. 3A as triangular with a planar contour. Likewise, front surface 316A and the rear surface may have generally planar surface contours. However, the front, rear, and side faces may be of a different shape or surface contour, examples of which will be seen in further embodiments described herein.

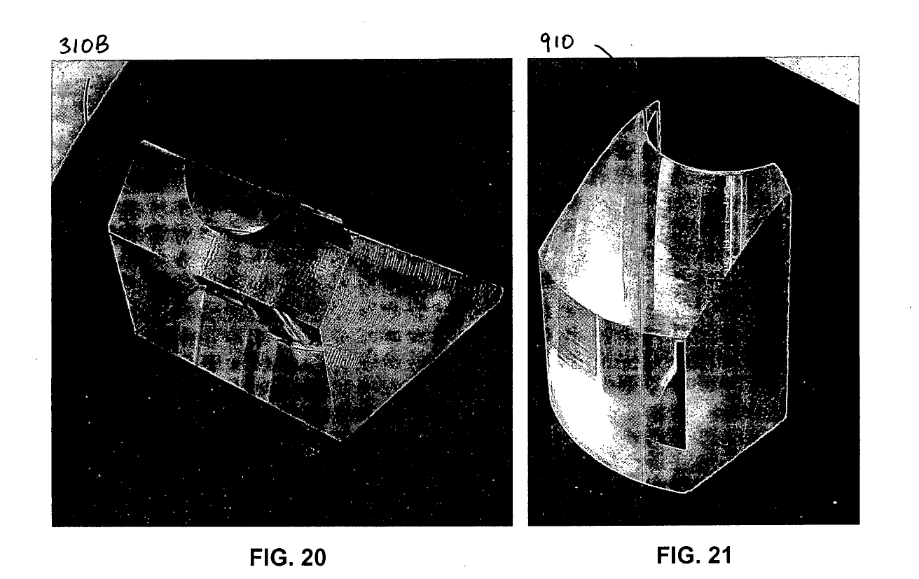

FIG. 3B is a diagram illustrating a prism 310B according to an embodiment of the present invention. Prism 310B is a prism that could be used in the rolled print scanner 100 of FIG. 1 in place of prism 110. Prism 310B can be thought of as a section of a five-sided polyhedron (prism 300) that remains after a radial section 320 is removed from a platen side and a front corner section 330 is removed as shown in FIG. 3B. The slot remaining after the removal of radial section 320 and front corner section 330 is used for platen 312B. Prism 310B includes a top face 322B, which is the platen side, a first front face 316B, a second front face 317 created when front corner section 330 is removed, two approximately parallel side faces (only side face 318B is shown), and a rear face (not shown). Among other things, removing section 330 reduces the relative size of prism 310B compared to prism 310A, making it more compact and making it relatively durable as it avoids the presence of a more sharp or pointed edge. A sharp or pointed edge can be more difficult to handle and more vulnerable to breakage. FIG. 4 is a diagram illustrating different perspective views of prism 310B of FIG. 3B. A photograph of an example of prism 310B is shown in FIG. 20.

Referring back to FIG. 1, light from illumination system 130 travels along optical path 135, enters light input face 114 (a bottom face) and is incident upon platen 112. (In an alternative embodiment, light from illumination system 130 enters rear face 119 or a side face (for example, side face 118). Light can also travel in a reverse direction by reconfiguring the scanner and placement of illumination and camera systems and shaping prism 110, 310 accordingly.) Light reflected out of prism 110 through output face 116 (a front face) passes along optical path 145 to camera system 150.

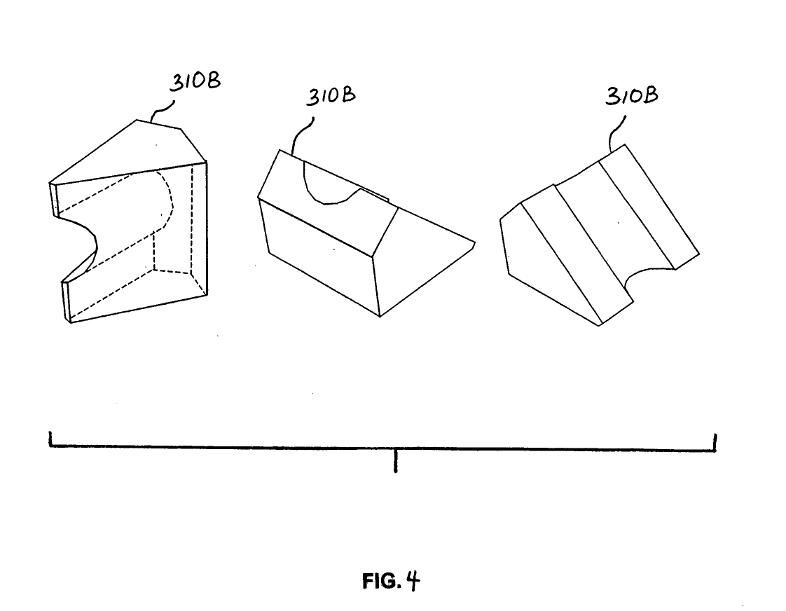

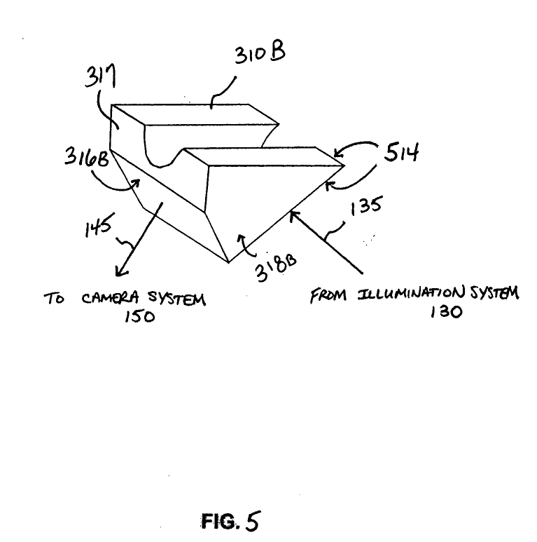

In FIG. 5, prism 310B is shown. As illustrated in FIG. 5, light from illumination system 130 enters rear face 514. In an alternative embodiment, light from illumination system 130 enters a side face (for example, side face 218B). As shown in FIG. 5, prism 310B has what may be considered two front faces, a lower front face 316B and an upper front face 317. Light reflected out of prism 310B exits through front face 316B. In an alternative embodiment, light from illumination system 130 enters front face 316B and exits through rear face 514.

The resulting illumination of a print can be different, depending upon the orientation of the incident light. When a digit is placed in intimate contact with platen 112, the TIR within the platen's bulk material is broken by the ridges of the digit and an image is formed. The image of valleys and ridges can be viewed in the vicinity of camera system 150. Depending upon the orientation of the incident light, ridge areas may appear relatively dark, while valleys and background areas are relatively bright in a captured print image. This is called “bright-field illumination.” With bright-field illumination, incident light greater than a critical angle of incidence is internally reflected at a platen surface and detected by a detector. Air-filled valleys and background areas appear relatively bright in a detected print image because much of the light in these areas reflects at the platen/air interface and is detected. Ridges and other surface features that contact the platen surface interrupt the total internal reflection. Light at these ridge areas refracts through the platen/digit interface and is partially absorbed and dispersed. Since only a small fraction of incident light in these ridge areas is reflected to the detector, these ridge areas appear relatively dark in a detected print image.

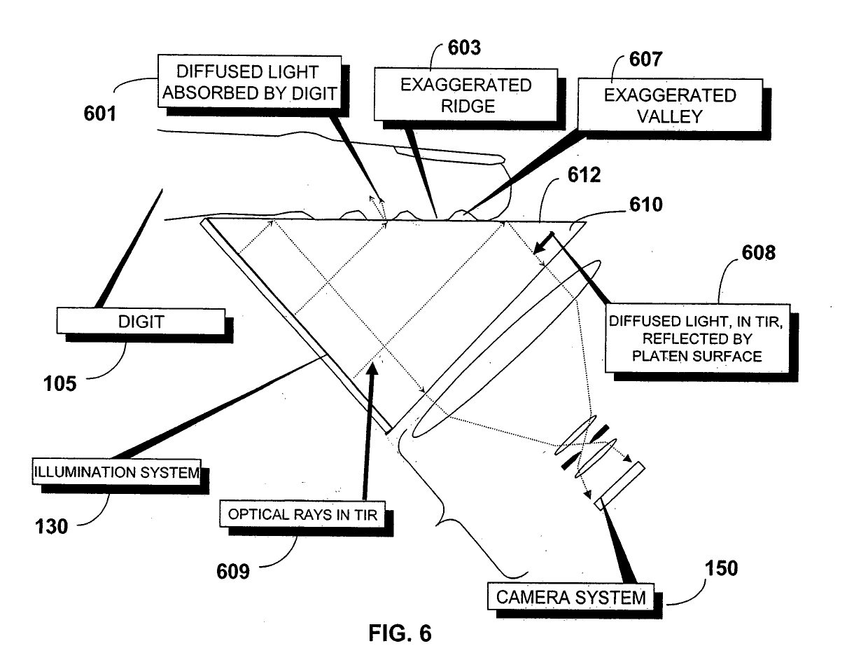

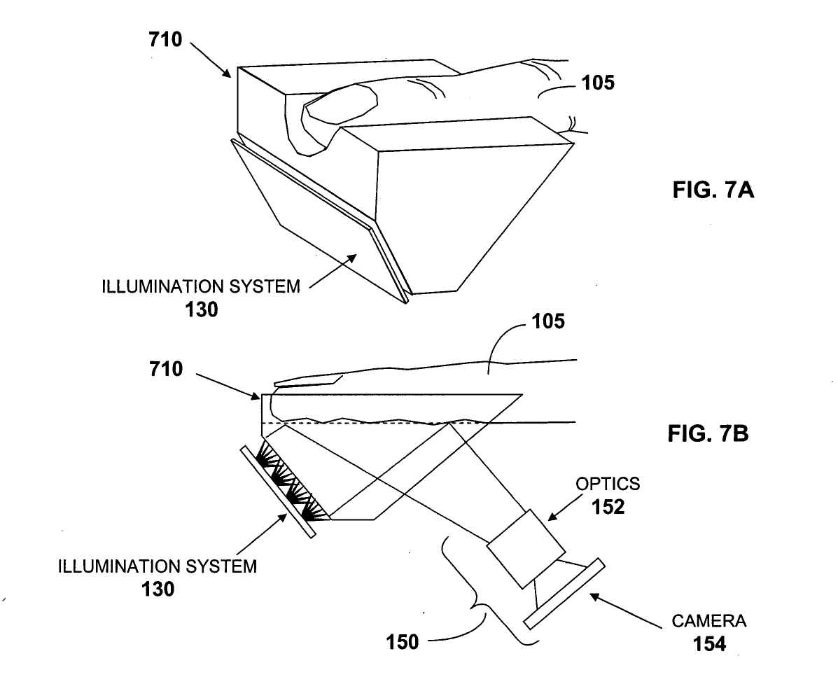

FIG. 6 illustrates an example of a live print scanner configured for bright-field illumination. Digit 105 is placed on a platen 612 of a prism 610. Digit 105 may alternatively be placed pointing in the opposite direction. Illumination system 130 is placed facing one face of the prism 610, and camera system 150 is placed at the opposite face of the prism 610. Light from the illumination system 130 travels through prism 610 as optical rays 609 which are incident upon platen 612. Light 601 is absorbed by digit 105 at one of ridges 603 and areas that are in contact with platen 612. Light 608, in TIR, is reflected by platen 612 at the valleys 607 of the digit 105 and areas that are not in contact with platen 612. Light exiting prism 610 enters camera system 150 for detection. FIGS. 7A and 7B illustrate cross sectional views of bright field illumination, as just described, using a prism 710 according to an embodiment of the present invention.

Alternatively, ridges and areas of a digit that are in contact with a platen can scatter and reflect light and an image of the print pattern having opposite white/black areas is detected. This is called “dark-field illumination.” With dark-field illumination, the illumination source is not directly imaged by the optics onto the detector. This causes the areas of the platen not in contact with the digit to appear relatively dark. Where the parts of the digit touch the platen and break TIR, light from the illumination source entering the digit is diffused and reflected back into the prism through the optics and imaged onto the detector. The result is a contrast created between ridge and valley areas, such that there is no light directed onto the detector at the valley and background areas not in contact with the platen surface which then appear relatively dark, while light is scattered from ridge areas or other areas in contact with the platen surface which then appear relatively bright in a captured print image.

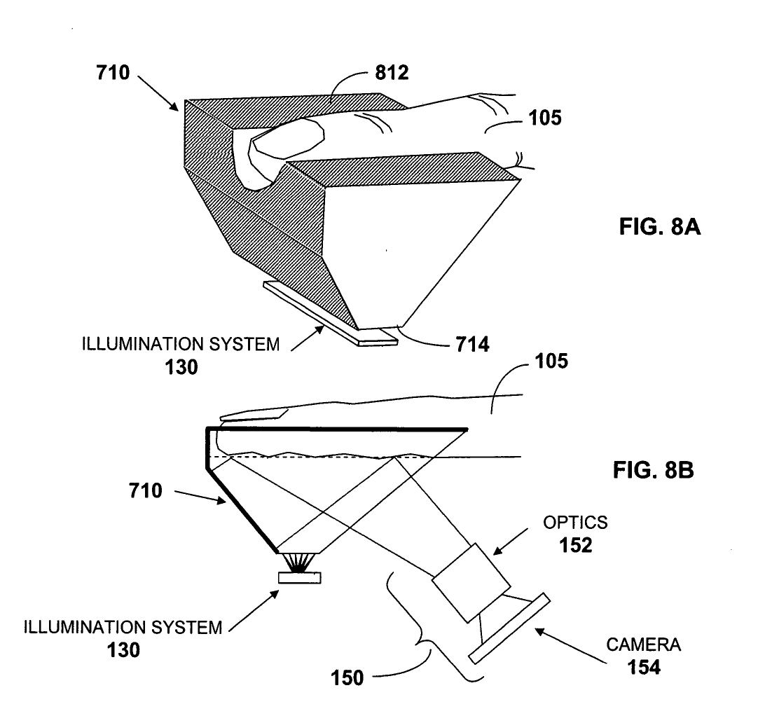

FIGS. 8A and 8B illustrate cross sectional views of dark field illumination using a prism 710 according to an embodiment of the present invention. In this embodiment, illumination system 130 is placed facing bottom face 714 of prism 710.

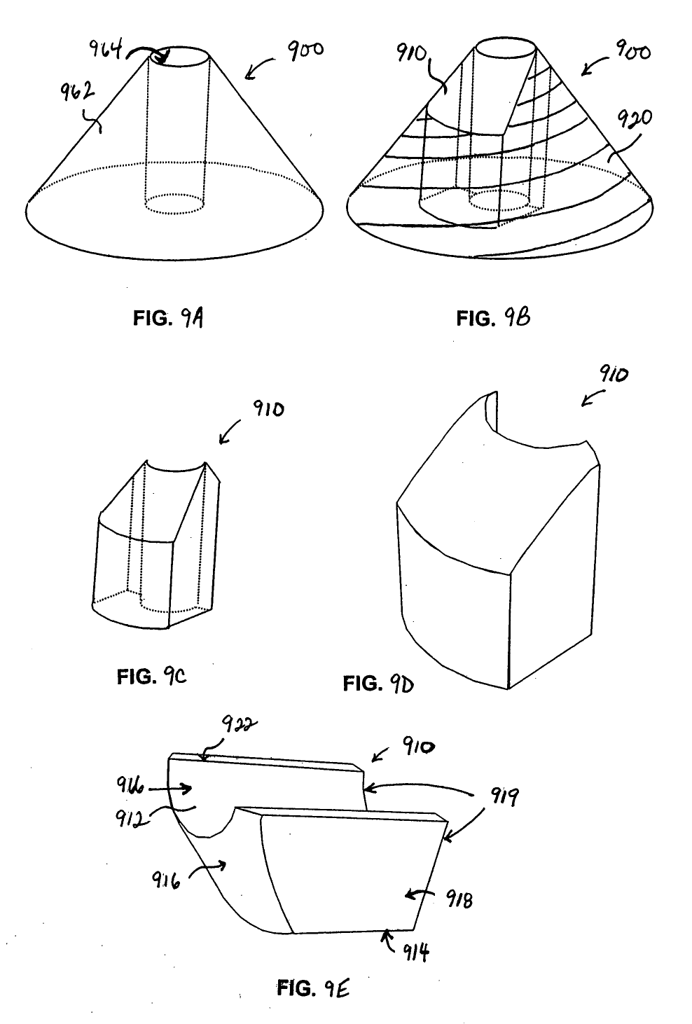

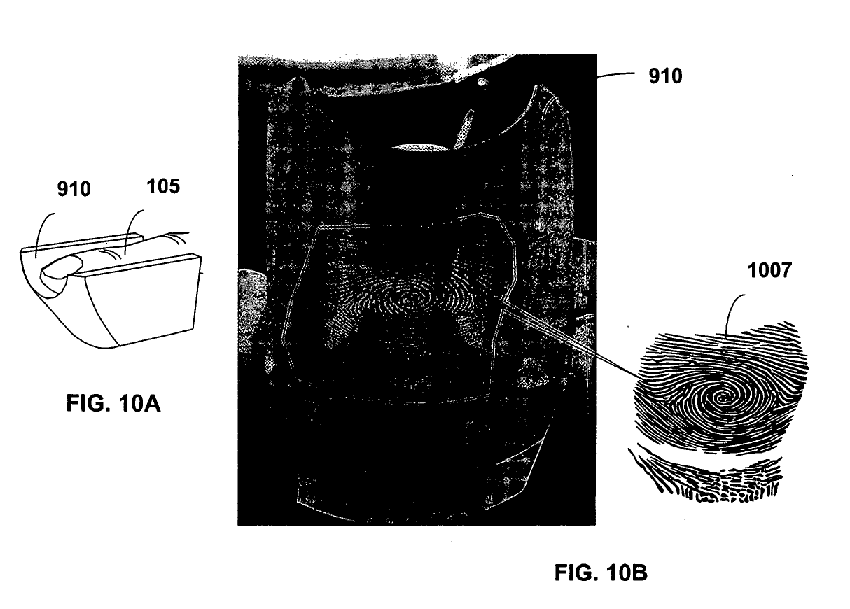

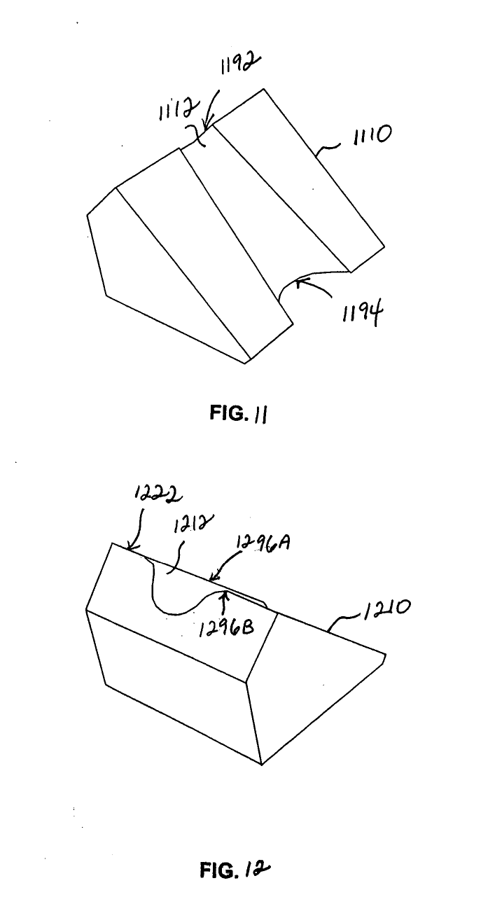

Prism 110 of FIG. 1 can be thought of as a section of a conical prism 900 as shown in FIGS. 9A-9C. FIG. 9A illustrates a conical prism in which a solid transparent cone 962 has a central hole 964 through its central axis. FIG. 9B illustrates conical prism 900 with a prism section 910 which is representative of prism 110 of FIG. 1, according to an embodiment of the present invention. FIG. 9C illustrates prism section 910 with the remainder 920 of conical prism 900 removed. FIGS. 9D and 9E illustrate alternate views of prism section 910. As shown in FIG. 9E, prism section 910 includes a top face 922 with a concave area in between two edge areas. The concave area corresponds to a surface area portion 966 along central hole 964. The portion 966 creates a slot which is used for platen 912. Prism section 910 also includes a front face 916, which consists of a portion of an arcuate surface of conical prism 900. Prism section 910 also includes a rear face 919, a bottom face 914, and two approximately parallel side faces (only side face 918 is shown). Prism section 910 can be used as a prism as described above for prism 110. An example of a print image 1007 using prism section 910 can be seen in FIG. 10. A photograph of an example of prism section 910 is shown in FIG. 21.

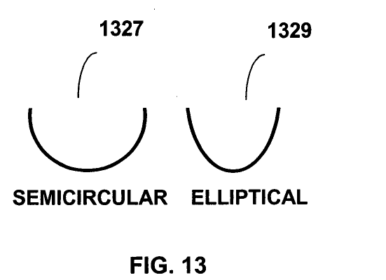

The slots used for platens 112, 312A, 312B, and 912 may be of different shapes, according to embodiments of the present invention. FIG. 11 is a diagram illustrating a prism 1110 having a tapered slot 1112 according to an embodiment of the present invention. A first end 1192 of tapered slot 1112 has a smaller width than a second end 1194. In certain applications, such a tapered shape may aid a user in proper placement of a digit in a desired direction along the slot. FIG. 12 is a diagram illustrating a prism 1210 having a non-cylindrical (flared) slot 1212 according to an embodiment of the present invention. Elongate areas 1296A, 1296B where slot 1212 meets planar portions of top face 1222 are rounded or beveled. Such a contour may aid a user or provide additional comfort in the proper positioning of a digit on a platen within the slot. FIG. 13 shows possible alternative shapes for the slot itself, including a semicircular 1327 shape and an elliptical 1329 shape. It would be understood by those skilled in the art that the slots are not limited to these shapes.

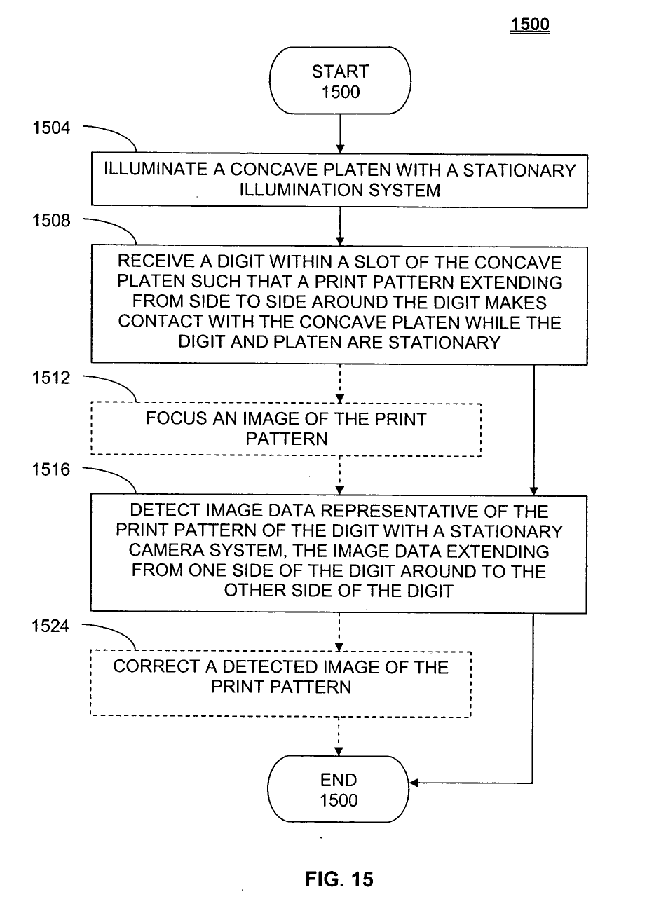

A method 1500 for scanning a roll print image of a digit having a print pattern using a prism such as those in the embodiments described above will now be described with reference to FIG. 15. In step 1504, a concave platen is illuminated with a stationary illumination system. In step 1508, a digit is received within a slot of the concave platen such that a print pattern extending from side to side around the digit makes contact with the concave platen while the digit and platen remain stationary. In step 1516, image data representative of the print pattern is detected with a stationary camera system, the image data representative of the print pattern extending from one side of the digit around to the other side of the digit. In another embodiment, the method 1500 further includes step 1512, which includes focusing an image of the print pattern prior to detecting image data. A system for scanning a digit having a print pattern includes means for performing the steps of method 1500.

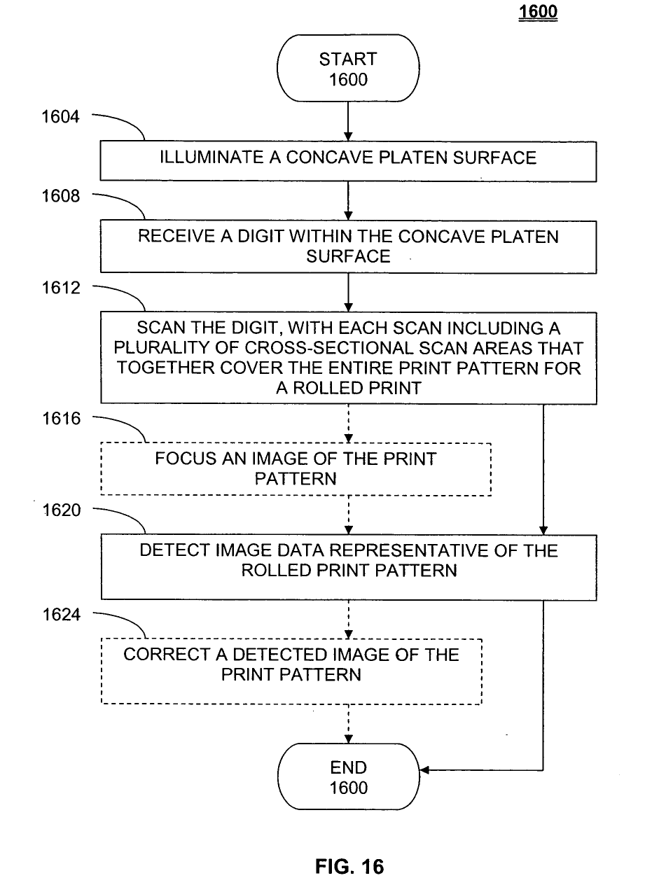

A method 1600 for capturing a rolled print pattern of a digit having a print pattern using a prism such as those in the embodiments described above will now be described with reference to FIG. 16. In step 1604, a concave platen surface is illuminated. In step 1608, a digit is received within the concave platen surface such that a print pattern extending from side to side around the digit makes contact with the concave platen surface. In step 1612, the digit is scanned. During step 1612, at least one of an illumination system and a camera system moves during a scan, with each scan including a plurality of cross-sectional scan areas that together cover the entire print pattern for a rolled print. For example, in one embodiment, at least one of an illumination system and a camera system moves in a linear path along the length of the digit. In another embodiment, at least one of an illumination system and a camera system moves in a linear path perpendicular to the digit. In a further embodiment, at least one of an illumination system and a camera system moves in an arcuate path around and perpendicular to the digit. In step 1620, image data representative of the rolled print pattern is detected. In another embodiment, the method 1600 further includes step 1616, which includes focusing an image of the print pattern prior to detecting image data. A system for capturing a rolled print pattern of a digit includes means for performing the steps of method 1600.

Methods 1500 and 1600 include further embodiments in which the rolled print pattern image is corrected due to the concave platen surface causing some foreshortening in the print pattern image along the print sides See optional step 1524 in FIG. 15 and optional step 1624 in FIG. 16. In such example embodiments, the rolled print pattern image is “unrolled” or “flattened” to make it appear as though the digit was rolled on a flat surface.

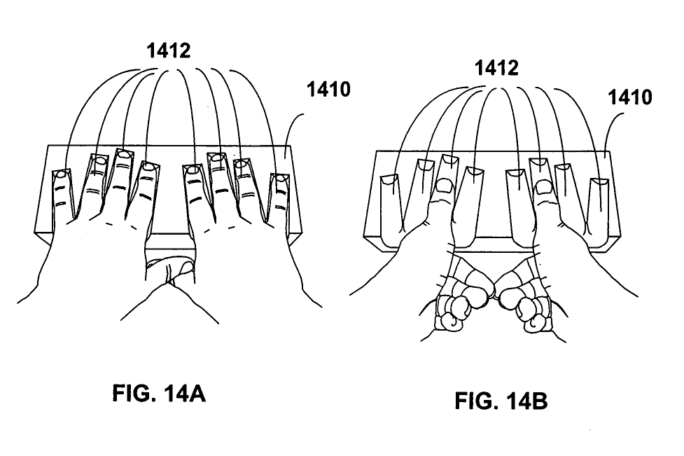

For the sake of simplicity in describing the present invention, single digit prisms have been described. However, the present invention also includes prisms that can accommodate multiple digits. For example, in one embodiment, a prism 1410 includes eight concave platen slots 1412 as shown in FIGS. 14A and 14B. A prism such as prism 1410 can accommodate up to eight digits at a time. Therefore, four fingers from each hand can be scanned simultaneously. In order to capture ten prints (e.g., four fingers and a thumb from each hand of a person), only two scanning instances needs to occur: one for eight fingers (as shown in FIG. 14A), and one for two thumbs (as shown in FIG. 14B).

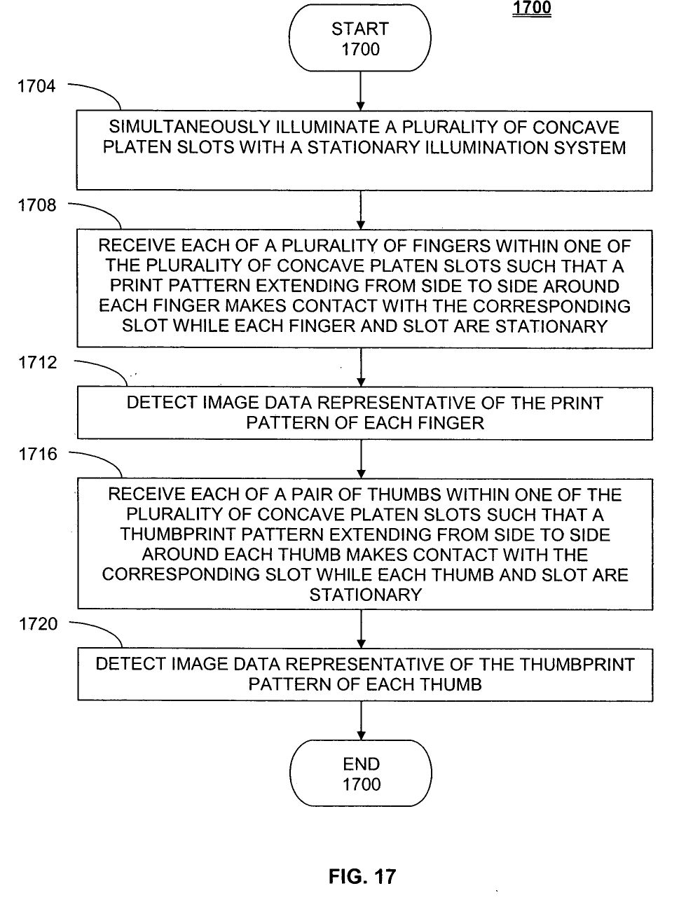

A method 1700 for capturing a rolled print patterns of the fingers and thumbs of a person's hands using a prism such as that in the embodiment described above will now be described with reference to FIG. 17. In step 1704, a plurality of concave platen slots are illuminated simultaneously with a stationary illumination system. In step 1708, each of a plurality of fingers is received within one of the plurality of concave platen slots (such as concave platen slots 1412 of FIGS. 14A and 14B) such that a print pattern extending from side to side around each finger makes contact with the corresponding slot while each finger and slot are stationary. In step 1712, image data representative of the print pattern of each finger is detected. In step 1716, each of a pair of thumbs is received within one of the plurality of concave platen slots (such as concave platen slots 1412 of FIGS. 14A and 14B) such that a print pattern extending from side to side around each thumb makes contact with the corresponding slot while each thumb and slot are stationary. In step 1720, image data representative of the thumbprint pattern of each thumb is detected.

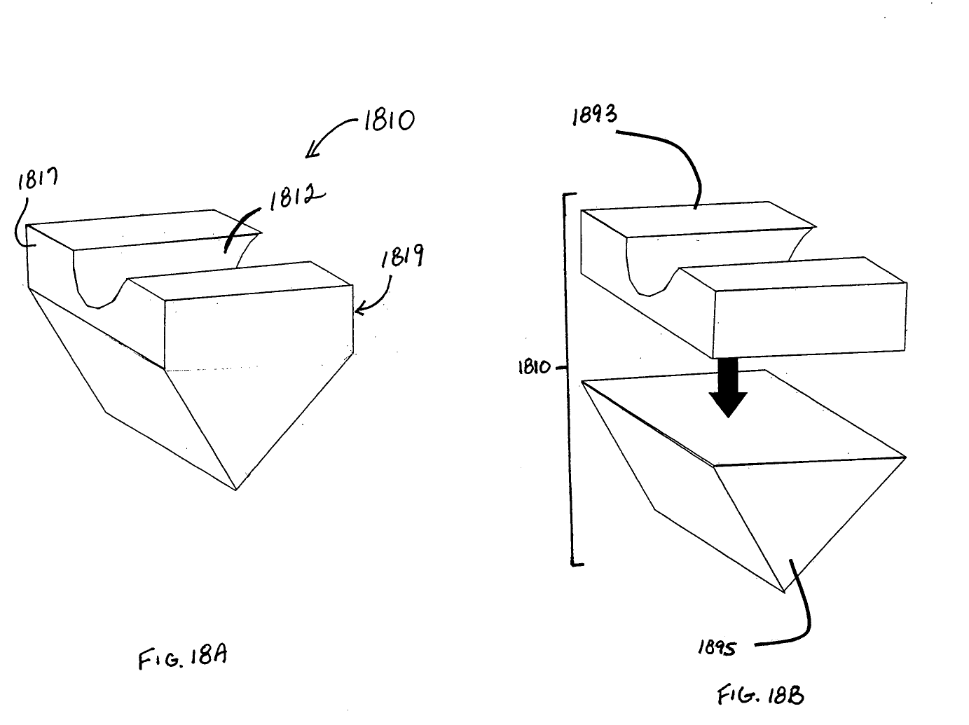

As would be understood by persons skilled in the art, all of the prisms described herein may be of slightly different shapes as those described, without taking away from the present invention. For example, the prism faces may have shapes or surface contours that differ from one prism to another. For instance, see prism 1810 of FIG. 18A. Prism 1810 has a concave platen 1812 that forms a slot, a front face 1817, and a rear face 1819. Front face 1817 and rear face 1819 are substantially parallel to each other and substantially perpendicular to the slot formed by concave platen 1812. Prism 1810 can be thought of as a section of a five-sided prism (such as prism 300 of FIG. 3B) that remains after a radial section is removed (similar to radial section 320 of FIG. 3B) and front and rear corner sections are removed (similar to the removal of front corner section 330 of FIG. 3B).

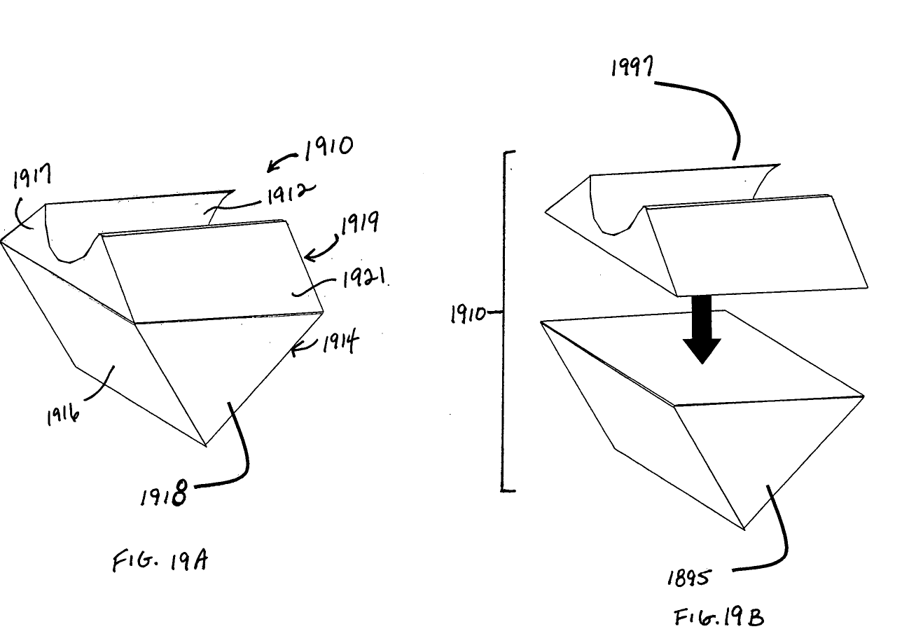

Prism 1910 of FIG. 19A illustrates yet another prism shape. Prism 1910 has a bottom portion that includes two triangular, substantially parallel, lower side faces (only lower side face 1918 is shown) connected via a lower front face 1916 and a lower rear face 1914. Prism 1910 also has an upper portion that includes a concave platen 1912 that forms a slot and is substantially parallel to the lower side faces, as well as a front face 1917 and a rear face 1919 that are substantially parallel to each other and substantially perpendicular to the slot. Along the length of the slot are upper side faces (only upper side face 1921 is shown) that slope inward from the lower side faces toward the edges of the slot. The upper side faces may be planar or may be arcuate.

Furthermore, the prisms and platens described herein do not need to be formed from only one block of material. Alternatively, a prism/platen combination can be formed from two or more components. For example, a prism/platen combination can be created by placing a platen attachment made out of an optically transparent material (such as plastic, glass, silicone, or other suitable optical material) in optical contact with an optical element base, such as a standard triangular prism. For instance, prism 1810 of FIG. 18A can be formed by attaching platen attachment 1893 to an optical element base 1895, as shown in FIG. 18B. As another example, prism 1910 of FIG. 19A can be formed by attaching platen attachment 1997 to optical element base 1895 as shown in FIG. 19B. The platen attachment can be permanently or temporarily (i.e., removably) attached to the surface of the standard prism. A platen attachment can be permanently attached to the prism using an optically clear adhesive, for example a glue. A removable platen attachment is useful if, for example, the platen attachment needs to be replaced or cleaned. A removable platen attachment can be attached to the prism using a substance such as oil, alcohol, water, or a similar non-permanent (e.g., non-glue-like) substance that will displace air. If the platen attachment is made of silicone, it can be removably attached to the prism without using any other substance.

One advantage of the present invention is that it allows rolled print data to be captured easily and quickly without mechanical rotation of a digit or complex movement of a scanner element. As described above, even the DOJ goal of capturing data for a ten-print format including rolled prints in less than one minute can be met. A user can quickly place each digit sequentially on a platen of a prism, such as prisms 110, 310, and 910, according to embodiments of the invention. In addition, or as an alternative, multiple prisms 110, 310, 910 can be arranged near each other, or a single prism 1410 with multiple platen slots 1412 can be used, so that rolled prints of more than one digit at a time can be captured.

As described herein, the present invention can be used to detect a roll print pattern in one or more scans of all or part of individual digits or groups of digits on either or both hands or feet.

Example embodiments of the methods, systems, and components of the present invention have been described herein. As noted elsewhere, these example embodiments have been described for illustrative purposes only, and are not limiting. Other embodiments are possible and are covered by the invention. Such embodiments will be apparent to persons skilled in the relevant art(s) based on the teachings contained herein. Thus, the breadth and scope of the present invention should not be limited by any of the above-described exemplary embodiments, but should be defined only in accordance with the following claims and their equivalents.

1. A system for scanning a digit having a print pattern, comprising:
a prism having a concave platen surface to receive the digit, and light input and output faces;
an illumination system configured to illuminate the concave platen surface; and
a camera system including a camera that detects image data representative of a rolled print in a scan,
wherein each of the digit, the platen surface, the illumination system, and the camera system is stationary during the scan, the scan including a cross-sectional scan area that substantially covers the print pattern for the rolled print.

2. The system of claim 1, wherein the camera system further includes a camera optical system that focuses an image of the rolled print onto the camera.

3. The system of claim 1, wherein the prism and the illumination system are configured for bright field illumination.

4. The system of claim 1, wherein the prism and the illumination system are configured for dark field illumination.

5. The system of claim 1, further comprising a platen, wherein the platen is the concave platen surface of the prism.

6. The system of claim 1, further comprising a platen, wherein the platen is a concave surface of a transparent material placed in optical contact with the concave platen surface of the prism.

7. The system of claim 6, wherein the transparent material is a protective silicone layer.

8. The system of claim 6, wherein the transparent material is an ultra-violet cured, cross-linked polyacrylate coating with controlled compliance.

9. The system of claim 6, wherein the transparent material is soft and conforming to compensate for slight physical variations from digit to digit.

10. The system of claim 1, wherein the concave platen surface is a slot having an elongate concave shape between a pair of side edges.

11. The system of claim 1, wherein the prism is a modified solid polyhedron that comprises:
a top face with a slot having an elongate concave shape between a pair of side edges, the slot forming the concave platen surface.

12. The system of claim 11, wherein the prism further comprises:
a rear face at a first end of the slot that is the light input face; and
a front face at a second end of the slot that is the light output face.

13. The system of claim 11, wherein the prism further comprises:
a bottom face opposite the top face that is the light input face; and
a front face at an end of the slot that is the light output face.

14. The system of claim 11, wherein the prism further comprises:
a side face approximately perpendicular to the top face that is the light input face; and
a front face at an end of the slot that is the light output face.

15. The system of claim 11, further comprising a platen, wherein the platen is the slot of the prism.

16. The system of claim 1, wherein the concave platen surface is a tapered slot having an elongate concave shape between a pair of side edges wherein a first width at a first end of the slot is smaller than a second width at a second end of the slot.

17. The system of claim 1, wherein the concave platen surface is a flared slot having an elongate concave shape between a pair of side edges such that elongate areas where the slot meets the side edges are rounded.

18. The system of claim 1, wherein the concave platen surface is a slot having a semicircular shape.

19. The system of claim 1, wherein the concave platen surface is a slot having an elliptical shape.

20. The system of claim 1, wherein the prism is a solid modified polyhedron that comprises an approximately triangular cross-section along a direction perpendicular to a plane of an optical axis of an illumination light from the illumination system.

21. The system of claim 1, wherein the prism is a solid modified polyhedron that comprises an approximately triangular cross-section along a direction perpendicular to a central axis of a slot formed by the concave platen surface.

22. The system of claim 1, wherein the prism is a solid modified polyhedron that comprises:
a first triangular side face; and
a second triangular side face approximately parallel with the first triangular side face.

23. The system of claim 22, wherein the concave platen surface is a tapered slot such that a first width at a first end of the slot is smaller than a second width at a second end of the slot.

24. The system of claim 22, wherein the concave platen surface is a flared slot such that elongate areas where the slot meets planar portions of a top face of the prism are rounded.

25. The system of claim 22, wherein the concave platen surface is a slot having a semicircular shape.

26. The system of claim 22, wherein the concave platen surface is a slot having an elliptical shape.

27. The system of claim 1, wherein the prism is a solid modified polyhedron that comprises a polygonal cross-section along a direction perpendicular to a plane of an optical axis of an illumination light from the illumination system.

28. The system of claim 1, wherein the prism is a solid modified polyhedron that comprises a polygonal cross-section along a direction perpendicular to a central axis of a slot formed by the concave platen surface.

29. The system of claim 1, wherein the prism is a solid modified polyhedron that comprises:
a first polygonal side face; and
a second polygonal side face of the same size and shape of the first polygonal side face that is approximately parallel with the first polygonal side face.

30. The system of claim 29, wherein the concave platen surface is a tapered slot such that a first width at a first end of the slot is smaller than a second width at a second end of the slot.

31. The system of claim 29, wherein the concave platen surface is a flared slot such that elongate areas where the slot meets planar portions of a top face of the prism are rounded.

32. The system of claim 29, wherein the concave platen surface is a slot having a semicircular shape.

33. The system of claim 29, wherein the concave platen surface is a slot having an elliptical shape.

34. The system of claim 1, wherein the prism is a solid modified polyhedron that comprises:
a first side face;
a second side face approximately parallel with the first side face; and
a top face having an elongate radial concave section that forms the concave platen surface such that a central axis of the radial concave section is approximately parallel with the first and second side faces, and such that the digit can be received in the concave platen surface.

35. The system of claim 34, wherein one end of the concave platen surface forms an arcuate indentation in a rear face.

36. The system of claim 34, wherein one end of the concave platen surface forms an arcuate indentation in a front face.

37. The system of claim 34, wherein the concave platen surface is a tapered slot such that a first width at a first end of the slot is smaller than a second width at a second end of the slot.

38. The system of claim 34, wherein the concave platen surface is a flared slot such that elongate areas where the slot meets planar portions of the top face are rounded.

39. The system of claim 34, wherein the concave platen surface is a slot having a semicircular shape.

40. The system of claim 34, wherein the concave platen surface is a slot having an elliptical shape.

41. The system of claim 34, wherein the light input face is a rear face and the light output face is a front face.

42. The system of claim 34, wherein the light input face is a rear face and the light output face is a lower front face.

43. The system of claim 34, wherein the light input face is a front face and the light output face is a rear face.

44. The system of claim 34, wherein the light input face is one of the first side face and the second side face, and the light output face is a front face.

45. The system of claim 34, wherein the prism further comprises:
a bottom face opposite the top face.

46. The system of claim 45, wherein the light input face is the bottom face and the light output face is a front face.

47. The system of claim 45, wherein the light input face is the bottom face and the light output face is a lower front face.

48. The system of claim 1, wherein the prism is shaped like a subsection of a solid transparent cone having a central hole through its central axis, the prism comprising:
a top face including a portion of the circumference of the central hole that forms a slot in which the digit can be received;
a front face including a portion of an arcuate surface of the cone that meets the top face at one end of the slot;
a pair of approximately parallel side faces on each side of the slot that meet opposite edges of the slot and opposite edges of the front face; and
a bottom face opposite the slot that is approximately perpendicular to the pair of side faces and that meets bottom edges of the side faces and the front face.

49. The system of claim 48, wherein the slot is tapered such that a first width at a first end of the slot is smaller than a second width at a second end of the slot.

50. The system of claim 48, wherein the slot is flared such that elongate edges of the slot are rounded.

51. The system of claim 48, wherein the slot has a semicircular shape.

52. The system of claim 48, wherein the slot has an elliptical shape.

53. The system of claim 48, wherein the light input face is the bottom face and the light output face is the front face.

54. The system of claim 48, wherein the prism further comprises:
a rear face opposite the front face that is approximately perpendicular to the side faces and the bottom face and meets rear edges of the side faces, the bottom face, and the front face.

55. The system of claim 54, wherein the light input face is the rear face and the light output face is the front face.

56. The system of claim 1, wherein the light input and output faces are located on the exterior surface of the prism such that an illumination light from the illumination system can pass through the light input face to illuminate an imaging area, said imaging area including the concave platen surface, and an image of the print pattern can pass through the light output face for detection by the camera system.

57. The system of claim 1, wherein the prism comprises:
a platen attachment that includes the concave platen surface; and
an optical element base,
wherein the platen attachment is placed in optical contact with the optical element base.

58. The system of claim 57, wherein the optical element base is a triangular prism section.

59. The system of claim 57, wherein the platen attachment is made of an optically transparent material.

60. The system of claim 57, wherein the platen attachment is permanently attached to the optical element base.

61. The system of claim 60, wherein the platen attachment is adhered to the optical element base with an optically clear adhesive.

62. The system of claim 57, wherein the platen attachment is removable from the optical element base.

63. A method for scanning a digit having a print pattern, the method comprising:
illuminating, with a stationary illumination system, a concave platen;
receiving the digit within a slot of the concave platen such that the print pattern extending from side to side around the digit makes contact with the concave platen while the digit and platen are stationary; and
detecting, with a stationary camera system, image data representative of the print pattern of the digit extending from one side of the digit around to the other side of the digit.

64. The method of claim 63, further comprising:
focusing an image of the print pattern prior to the detecting step.

65. The method of claim 63, further comprising:
correcting a detected image of the print pattern.

66. The method of claim 65, wherein the correcting step includes flattening the detected image of the print pattern to make it appear as though the digit was rolled on a flat surface.

67. The method of claim 63, further comprising:
configuring the stationary illumination system for bright field illumination.

68. The method of claim 63, further comprising:
configuring the stationary illumination system for dark field illumination.

69. A system for scanning a digit having a print pattern, the system comprising:
stationary means for illuminating a concave platen;
means for receiving the digit within a slot of the concave platen such that the print pattern extending from side to side around the digit makes contact with the concave platen while the digit and platen are stationary; and
stationary means for detecting image data representative of the print pattern of the digit extending from one side of the digit around to the other side of the digit.

70. The system of claim 69, wherein the means for illuminating is configured for bright field illumination.

71. The system of claim 69, wherein the means for illuminating is configured for dark field illumination.

72. The system of claim 69, further comprising:
means for focusing an image of the print pattern prior to detecting image data.

73. The system of claim 69, further comprising:
means for correcting a detected image of the print pattern.

74. The system of claim 73, wherein the means for correcting includes means for flattening the detected image of the print pattern to make it appear as though the digit was rolled on a flat surface.

75. A prism for use in a system for scanning a rolled print pattern of a digit, comprising:
a first side face;
a second side face approximately parallel with the first side face; and
a top face having an elongate radial concave section that forms a slot such that a central axis of the radial concave section is approximately parallel with the first and second side faces, and such that the digit can be received in the slot.

76. The prism of claim 75, wherein one end of the slot forms an arcuate indentation in a rear face.

77. The prism of claim 75, wherein one end of the slot forms an arcuate indentation in a front face.

78. The prism of claim 75, wherein the slot is tapered such that a first width at a first end of the slot is smaller than a second width at a second end of the slot.

79. The prism of claim 75, wherein the slot is flared such that elongate areas where the slot meets planar portions of the top face are rounded.

80. The prism of claim 75, wherein the slot has a semicircular shape.

81. The prism of claim 75, wherein the slot has an elliptical shape.

82. The prism of claim 75, further comprising light input and output faces on the exterior surface of the prism such that an illumination light can pass through the light input face to illuminate an imaging area, said imaging area including the slot, and an image of a print pattern can pass through the light output face for detection by a camera system.

83. The prism of claim 75, wherein a rear face is a light input face and a front face is a light output face.

84. The prism of claim 75, wherein a rear face is a light input face and a lower front face is a light output face.

85. The prism of claim 75, wherein a front face is a light input face and a rear face is a light output face.

86. The prism of claim 75, wherein one of the first side face and the second side face is a light input face, and a front face is a light output face.

87. The prism of claim 75, further comprising:
a bottom face opposite the top face.

88. The prism of claim 87, wherein the bottom face is a light input face and a front face is a light output face.

89. The prism of claim 87, wherein the bottom face is a light input face and a lower front face is a light output face.

90. The prism of claim 75, wherein the prism has a structure that comprises:
a platen attachment that includes the slot; and
an optical element base,
wherein the platen attachment is placed in optical contact with the optical element base.

91. The prism of claim 90, wherein the optical element base is a triangular prism section.

92. The prism of claim 90, wherein the platen attachment is made of an optically transparent material.

93. The prism of claim 90, wherein the platen attachment is permanently attached to the optical element base.

94. The prism of claim 93, wherein the platen attachment is adhered to the optical element base with an optically clear adhesive.

95. The prism of claim 90, wherein the platen attachment is removable from the optical element base.

96. An optical element for use in a system for scanning a rolled print pattern of a digit, comprising:
a prism having an exterior surface shaped approximately like a subsection of a cone with a central hole through its central axis, wherein the prism exterior surface includes
a top face that forms a slot in which the digit can be received, the slot corresponding to portion of the circumference of the central hole; and
a front face including a portion of an arcuate surface of the cone that meets the top face at one end of the slot.

97. The optical element of claim 96, wherein the slot is tapered such that a first width at a first end of the slot is smaller than a second width at a second end of the slot.

98. The optical element of claim 96, wherein the slot is flared such that elongate edges of the slot are rounded.

99. The optical element of claim 96, wherein the slot has a semicircular shape.

100. The optical element of claim 96, wherein the slot has an elliptical shape.

101. The optical element of claim 96, further comprising light input and output faces on the exterior surface of the prism such that an illumination light can pass through the light input face to illuminate an imaging area, said imaging area including the slot, and an image of a print pattern can pass through the light output face for detection by a camera system.

102. A system for scanning a digit having a print pattern, comprising:
a concave platen surface to receive the digit;
an illumination system configured to illuminate the concave platen surface; and
a camera system including a camera that detects image data representative of a rolled print in a scan,
wherein each of the digit, the platen surface, the illumination system, and the camera system is stationary during the scan, the scan including a cross-sectional scan area that substantially covers the print pattern for the rolled print.

103. The system of claim 102, wherein the camera system further includes a camera optical system that focuse's an image of the rolled print onto the camera.

104. The system of claim 102, wherein the illumination system is configured for bright field illumination.

105. The system of claim 102, wherein the illumination system is configured for dark field illumination.

106. The system of claim 102, further comprising a platen, wherein the platen is the concave platen surface of the prism.

107. The system of claim 102, further comprising a platen, wherein the platen is a concave surface of a transparent material placed in optical contact with the concave platen surface of the prism.

108. The system of claim 107, wherein the transparent material is a protective silicone layer.

109. The system of claim 107, wherein the transparent material is an ultra-violet cured, cross-linked polyacrylate coating with controlled compliance.

110. The system of claim 107, wherein the transparent material is soft and conforming to compensate for slight physical variations from digit to digit.

111. The system of claim 102, wherein the concave platen surface is a slot having an elongate concave shape between a pair of side edges.

112. A system for scanning a digit having a print pattern, comprising:
a concave platen surface to receive the digit;
an illumination system configured to illuminate the concave platen surface; and
a camera system including a camera that detects image data representative of a rolled print in a scan,
wherein at least one of the camera system and the illumination system moves during the scan, each scan including a plurality of cross-sectional scan areas that together cover the entire print pattern for the rolled print.

113. The system of claim 112, wherein the illumination system is configured for bright field illumination.

114. The system of claim 112, wherein the illumination system is configured for dark field illumination.

115. The system of claim 112, wherein scan motion is a linear path along the length of the digit.

116. The system of claim 112, wherein scan motion is a linear path perpendicular to the digit.

117. The system of claim 112, wherein scan motion is an arcuate path around and perpendicular to the digit.

118. A method for capturing a rolled print pattern of a digit, comprising:
illuminating a concave platen surface;
receiving the digit within the concave platen surface;
scanning the digit, wherein at least one of a camera system and an illumination system moves during a scan, each scan including a plurality of cross-sectional scan areas that together cover the entire print pattern for a rolled print; and
detecting image data representative of the rolled print pattern.

119. The method of claim 118, further comprising:
configuring an illumination system for bright field illumination.

120. The method of claim 118, further comprising:
configuring an illumination system for dark field illumination.

121. The method of claim 118, wherein the scanning step comprises moving at least one of the camera system and the illumination system in a linear path along the length of the digit.

122. The method of claim 118, wherein the scanning step comprises moving at least one of the camera system and the illumination system in a linear path perpendicular to the digit.

123. The method of claim 118, wherein the scanning step comprises moving at least one of the camera system and the illumination system in an arcuate path around and perpendicular to the digit.

124. The method of claim 118, further comprising:
focusing an image of the print pattern prior to the detecting step.

125. The method of claim 118, further comprising:
correcting a detected image of the print pattern.

126. The method of claim 125, wherein the correcting step includes flattening the detected image of the print pattern to make it appear as though the digit was rolled on a flat surface.

127. A system for capturing a rolled print pattern of a digit, comprising:
means for illuminating a concave platen surface;
means for receiving the digit within the concave platen surface;
means for scanning the digit, wherein at least one of a camera system and an illumination system moves during a scan, each scan including a plurality of cross-sectional scan areas that together cover the entire print pattern for a rolled print; and
means for detecting image data representative of the rolled print pattern.

128. The system of claim 127, wherein the means for illuminating is configured for bright field illumination.

129. The system of claim 127, wherein the means for illuminating is configured for dark field illumination.

130. The system of claim 127, wherein the means for scanning comprises:
means for moving at least one of the camera system and the illumination system in a linear path along the length of the digit.

131. The system of claim 127, wherein the means for scanning comprises:
means for moving at least one of the camera system and the illumination system in a linear path perpendicular to the digit.

132. The system of claim 127, wherein the means for scanning comprises:
means for moving at least one of the camera system and the illumination system in an arcuate path around and perpendicular to the digit.

133. The system of claim 127, further comprising:
means for focusing an image of the print pattern prior to detecting image data.

134. The system of claim 127, further comprising:
means for correcting a detected image of the print pattern.

135. The system of claim 134, wherein the means for correcting includes means for flattening the detected image of the print pattern to make it appear as though the digit was rolled on a flat surface.

136. A prism for use in a system for scanning a rolled print pattern of at least one digit, comprising:
a first side face;
a second side face approximately parallel with the first side face; and
a top face having at least one elongate radial concave section that forms a slot such that a central axis of the radial concave section is approximately parallel with the first and second side faces, and such that the digit can be received in the slot.

137. The prism of claim 136, wherein the slot is tapered such that a first width at a first end of the slot is smaller than a second width at a second end of the slot.

138. The prism of claim 136, wherein the slot is flared such that elongate areas where the slot meets planar portions of the top face are rounded.

139. The prism of claim 136, wherein the slot has a semicircular shape.

140. The prism of claim 136, wherein the slot has an elliptical shape.

141. The prism of claim 136, further comprising light input and output faces on the exterior surface of the prism such that an illumination light can pass through the light input face to illuminate an imaging area, said imaging area including the slot, and an image of a print pattern can pass through the light output face for detection by a camera system.

142. The prism of claim 136, wherein the prism has a structure that comprises:
a platen attachment that includes the slot; and
an optical element base,
wherein the platen attachment is placed in optical contact with the optical element base.

143. The prism of claim 142, wherein the optical element base is a triangular prism section.

144. The prism of claim 142, wherein the platen attachment is made of an optically transparent material.

145. The prism of claim 142, wherein the platen attachment is permanently attached to the optical element base.

146. The prism of claim 145, wherein the platen attachment is adhered to the optical element base with an optically clear adhesive.

147. The prism of claim 142, wherein the platen attachment is removable from the optical element base.

148. A prism for use in a system for scanning a rolled print pattern of at least one digit, comprising:
a first side face;
a second side face approximately parallel with the first side face; and
a top face having a plurality of elongate radial concave sections that each form a slot such that a central axis of each radial concave section is approximately parallel with the first and second side faces, and such that one digit can be received in each slot simultaneously.

149. The prism of claim 148, wherein at least one slot is tapered such that a first width at a first end of the slot is smaller than a second width at a second end of the slot.

150. The prism of claim 148, wherein at least one slot is flared such that elongate areas where the slot meets planar portions of the top face are rounded.

151. The prism of claim 148, wherein at least one slot has a semicircular shape.

152. The prism of claim 148, wherein at least one slot has an elliptical shape.

153. The prism of claim 148, further comprising light input and output faces on the exterior surface of the prism such that an illumination light can pass through the light input face to illuminate an imaging area, said imaging area including the slots, and an image of a print pattern can pass through the light output face for detection by a camera system.

154. The prism of claim 148, wherein the prism has a structure that comprises:
a platen attachment that includes the slot; and
an optical element base,
wherein the platen attachment is placed in optical contact with the optical element base.

155. The prism of claim 154, wherein the optical element base is a triangular prism section.

156. The prism of claim 154, wherein the platen attachment is made of an optically transparent material.

157. The prism of claim 154, wherein the platen attachment is permanently attached to the optical element base.

158. The prism of claim 157, wherein the platen attachment is adhered to the optical element base with an optically clear adhesive.

159. The prism of claim 154, wherein the platen attachment is removable from the optical element base.

160. A method for scanning a plurality of digits having print patterns, the method comprising:
illuminating, with a stationary illumination system, a plurality of concave platen slots;
receiving each digit within one of the plurality of concave platen slots such that a print pattern extending from side to side around each digit makes contact with the corresponding concave platen slot while each digit and concave platen slot are stationary; and
detecting, with a stationary camera system, image data representative of the print pattern of each digit extending from one side of the digit around to the other side of the digit.

161. A method for scanning all digits of a person's hands having print patterns, the method comprising:
illuminating simultaneously, with a stationary illumination system, a plurality of concave platen slots;
receiving each of a plurality of fingers within one of the plurality of concave platen slots such that a print pattern extending from side to side around each finger makes contact with the corresponding concave platen slot while each finger and concave platen slot are stationary;
detecting, with a stationary camera system, image data representative of the print pattern of each finger extending from one side of the finger around to the other side of the finger;
receiving each of a pair of thumbs within one of the plurality of concave platen slots such that a thumbprint pattern extending from side to side around each thumb makes contact with the corresponding concave platen slot while each thumb and concave platen slot are stationary; and
detecting, with the stationary camera system, image data representative of the thumbprint pattern of each thumb extending from one side of the thumb around to the other side of the thumb.

162. A method for capturing rolled print patterns of a plurality of digits simultaneously, comprising:
illuminating a plurality of concave platen surfaces;
receiving each digit within one of the plurality of concave platen surfaces;
scanning the digits, wherein at least one of a camera system and an illumination system moves during a scan, each scan including a plurality of cross-sectional scan areas that together cover entire print patterns for rolled prints; and
detecting image data representative of the rolled print patterns.
